(19) United States
(12) Patent Application Publication
(10) Pub. No.: US 2024/0088750 A1
(43) Pub. Date: Mar. 14, 2024

(54) DOOR LEAF ASSEMBLY WITH FITTINGS EQUIPPED WITH AN ADD-ON MODULE FOR AUTONOMOUS POWER SUPPLY

(71) Applicant: CESKE VYSOKE UCENI TECHNICKE V PRAZE, 160 00 Praha 6 (CZ)

(72) Inventors: Vladimir JANICEK, Praha (CZ); Jiri KROUTIL, Tabor (CZ); Tomas TEPLY, Velke Prilepy (CZ)

(73) Assignee: CESKE VYSOKE UCENI TECHNICKE V PRAZE, 160 00 Praha 6 (CZ)

(21) Appl. No.: 18/272,633

(22) PCT Filed: Feb. 6, 2022
(86) PCT No.: PCT/CZ2022/050013

§ 371 Date: Jul. 17, 2023

(30) Foreign Application Priority Data
Feb. 7, 2021 (CZ) PV 2021-51

(51) Int. Cl. H02K 7/18; E05B 1/00; E05B 17/22; F03G 5/06; H02K 7/116

(52) U.S. Cl. CPC H02K 7/1853; E05B 1/003; E05B 17/22; F03G 5/065; H02K 7/116; E05B 47/0001

(57) ABSTRACT

A door leaf assembly with door fittings equipped with an add-on module for autonomous power supply, which includes a mechanically operated handle, where the add-on module for autonomous power supply includes at least one part, wherein each of the parts of the add-on module for autonomous power supply is inserted between at least a part of the door fittings and the door leaf. It is advantageous when the add-on module for autonomous power supply contains the central gearbox with the primary gearwheel and at least one secondary gearwheel. The primary gearwheel contains a hole for inserting the axis of the handle. Each secondary gearwheel is connected to one of the main shafts to drive the rotation of this main shaft, each main shaft being connected to either a single electric generator or to a block of at least two electric generators which are kinematically connected to each other.

### BACKGROUND AND SUMMARY

The invention deals, according to an aspect thereof, with an intelligent access system integrated in the body of handle fittings and powered by an integrated electricity generator driven by the motion of the handle. When a user moves the handle, an integrated electricity generator is set in motion; the electricity is then stored in an integrated electricity source and this generated energy is used to power integrated electrical circuits located in the body of the handle. This system can be used for automation and access management in buildings where the generated energy contributes to extending the time between necessary service interventions between replacing or recharging the integrated batteries.

Nowadays, conventional door fittings using a purely mechanical method of converting the rotary motion of the handle to latch control are being replaced with an intelligent system where users present their authorisation at the door (using an RFID tag or other wireless technology) and the door lets them in or blocks its opening based on set rules. This system is now widely used in administrative buildings where it is necessary to ensure authorised access of a large number of users to many rooms and common corridors. This system is usually designed as a centralised solution, where a main server maintains a connection with individual door systems (door handles) to which it sends an updated table with user identification codes and their authorisation to enter the door at regular intervals. A less common system, usually used with a small number of doors, is a decentralised system where each passageway and an attendance system installed on it is autonomous and no communication with the outside world is required. This system, of course, lacks the advantage of central management, monitoring of passageways and mutual coordination, or an automated mode enabling changes of individual authorisations on the fly, where a user gradually passes through the building and is directed based on the user's position. These systems require for their operation electronic devices located directly in the body of the handle (smart door fittings, intelligent access system).

These systems require an energy source to operate. With regard to the operating mode, it is possible to differentiate the level of door utilisation (hereafter universally referred to as a doorway) based on its position. While the building entrance door will certainly be used by all who enter and exit the building, the doorway to a utility room on the 3^{rd} underground floor might be used only a couple of times a month. For the rest of the time, they will be in a stand-by mode with minimal energy requirements.

Various types of primary or secondary cells or supercapacitors are primarily used as sources of electricity. The specific type determines the service life of the entire device without external service intervention in the form of energy source replacement or recharging. When designing such a system, it is necessary to take into account energy optimisation. This involves a detailed analysis of electricity consumption by the individual electronic and electromechanical components of the entire device. The optimal state is achieved by setting the operating mode so that the individual subcomponents consume only the strictly necessary amount of energy. At this point, we can consider the appropriate energy source and capacity of electricity stored within and whether it might be possible to obtain this energy using a method different than the conventional way of recharging or replacing the entire battery. In this case, it is possible to envisage an alternative power supply, depending on the environment in which the entire device is located (typically a door).

Some systems have a wired power supply, where a power cable can be run to the area where the handle is located. However, for some systems this is inappropriate or even impossible e.g. for design reasons (glass doors). For some doors, it is undesirable to install additional power cables as this would entail major mechanical intervention in the existing design. In our case, we will only consider systems with an integrated energy source. In addition to batteries, energy harvesters can also be used to power these devices in an advantageous embodiment; the harvesters are used to convert one of the so-called waste non-electrical energies into electrical energy. This, for example, applies to a solar cell, in which optical/light energy is converted to electrical energy. In the case of door systems, several principles can be used:
solar—by placing solar panels on the door surface. However, this is only applicable where there is sufficient light, ideally daylight.
b) piezoelectric—used for the conversion of mechanical energy. Usually, these elements are placed in the door hinge and utilise mechanical stress in a piezoelectric crystal.
c) electromagnetic—generally the movement of a ferromagnetic core inside a coil causing voltage induction

Syed Faizan-ul-Haq Gialni et al. in their paper titled Development of energy harvesting system using rotation mechanism of a revolving door, ARPN Journal of Engineering and Applied Sciences 10 (21), 10159-10163, describe the principle of installing an electromagnetic generator (motor) on a revolving door where the axis of the electric generator is coupled with the axis of the revolving door. The disadvantage of this solution lies in the overall magnitude of the implementation and the necessary construction interventions in the door structure. At the same time, this solution is not designed for conventional doors with single-acting hinges.

Grant Cechmanek in the Small Scale Energy Harvesting for Use with an Electronic Door Strike, diploma thesis, University Waterloo, 2016, describes the integration of an electric motor into a door hinge. However, for this embodiment, the existing door leaf must be modified, and the solution only achieves low power due to the low-speed generator.

Dale H. Litwhiler in A Door Motion Energy Harvesting System for Powering Electronic Door Lock, Proceedings of The 2014 IAJC/ISAM Joint International Conference ISBN 978-1-60643-379-9, describes a principle consisting of an integration of an electric motor into the door hinge, which is essentially the same as the above solution by Grant Cechmanek. Similarly, an intervention in the door leaf is also necessary.

The generator described in the patent document U.S. Pat. No. 9,431,927 B2 utilises the principle of a piezo generator, which is activated by turning a gearwheel attached to the door leaf, or by compressing a tube containing piezoelectric elements. Mechanical intervention in the door hinge and the door leaf is also necessary in this case.

In patent document US 2011/0254285 A1, the author Hanchet, JR. uses a system integrated in the locking mechanism of a lock, wherein an extended latch body, together with an integrated coil, forms an electromagnet assembly which is activated firstly by a user opening the door and secondly by the door closing and the latch engaging. During implementation, a complete replacement of the lock and its replacement with a mechanism including an integrated electromagnet is necessary.

In the European patent EP 2378041 B1, the author uses piezoelectric elements in general, which are moved by means of a wheel with protrusions that is driven by a door hinge. The system uses piezoelectric elements; their bending rate is small, so the output power will be small as well.

Ning Luiet. al. al in the Neural Network-based Prediction Algorithm for In-Door MultiSource Energy Harvesting System for Non-Volatile Processors, GLSVLSI '16: Proceedings of the 26th edition on Great Lakes Symposium on VLSI May 2016, Pages 275-280, https://doi.org/10.1145/2902961.2903037, uses the general principle of electricity generation using thermocouples, solar panels and piezoelectric elements. The article deals primarily with intelligent management of the energy transfer, rather than the mechanism of the use of individual generators as such. It only addresses the power management aspect of the problem, not the design itself.

Sreenidhi Prabba Rajeey et. al in the Prototype of energy harvesting door handles using polymer nanocomposite, Appl Nanosci 10, 1-13 (2020). https://doi.org/10.1007/sl3204-019-01027-z, uses a mixture of ZnO and polymer in a handle-driven generator. The mixture is applied to the body of the handle in a thin layer. A disadvantage is the need for special material and the necessary modification of the handle.

Clemens Cepnik et al.v Review on Electrodynamic Energy Harvesters—A Classification Approach. Micromachines 2013, 4, 168-196; doi:10.3390/mi4020168, SSN 2072-666X, describes the principles of several energy harvesters operating on the electrodynamic principle. It does not focus so much on the description of the areas of application where the particular energy harvester will be used, but rather on the possible configurations.

Aniket M. Dighade et al. in the Generation of Energy using Revolving Door, International Research Journal of Engineering and Technology (IRJET) e-ISSN: 2395-0056 Volume: 06 Issue: 01|January 2019 www.irjet.net p-ISSN: 2395-0072, describes a system using a revolving door to generate power by means of a transfer presumably to a generator (the material does not make this clear); the solution requires intervention in the revolving door system.

It is thus clear that in none of the above solutions is the energy harvester located directly in the body of the handle or in its immediate vicinity. None of these solutions is universally applicable and adaptable to a wide range of types and forms of door fittings available today. Similarly, there is no known sandwich method of integrating an energy harvesting device in order to upgrade any door fittings. There is no known example of the utilisation of small high-gear gearboxes integrated directly into the intermediate layer inserted between the door leaf and one piece of the fittings.

These disadvantages are eliminated by a door leaf assembly with door fittings equipped with a mechanically operated handle and an add-on module for autonomous power supply according to an aspect of the present invention, which has the advantage of simplicity of installation by inserting the module between the fittings and the door leaf. This solution does not change the appearance of the fittings, it does not overlap anything, it only increases the clearance of the entire fittings, which does not limit the user in any way, and it is possible to achieve the same appearance as the original fittings by choosing an appropriate finish of the add-on power supply module. The axis of the handle drives an internal set of generators configurable based on the required amount of generated power which generate an electric current usable for powering internal electronics that form a part of the access system integrated in handle fittings. No invasive interventions in the body of the existing door are necessary during installation. If needed, the device can also be uninstalled just as easily.

The door leaf assembly with door fittings with a mechanically operated handle is equipped with an add-on module for autonomous power supply that comprises at least one part, wherein each of the parts of the add-on module for autonomous power supply is inserted between at least a part of the door fittings and the door leaf.

Is it advantageous if the add-on module for autonomous power supply comprises at least two parts, wherein at least one of these parts is located on an opposite side of the door leaf than at least one other part of the add-on module for autonomous power supply.

In one advantageous embodiment, in the area where the add-on module for autonomous power supply is located, the assembly has a sandwich structure, wherein the successive layers of the sandwich structure are the door fittings, the add-on module for autonomous power supply or at least one part thereof, the door leaf and the door fittings.

In another advantageous embodiment, in the area where the add-on module for autonomous power supply is located, the assembly has a sandwich structure, wherein the successive layers of the sandwich structure are the door fittings, at least one part of the add-on module for autonomous power supply, the door leaf, at least one part of the add-on module for autonomous power supply and the door fittings.

In an advantageous embodiment, the add-on module for autonomous power supply comprises at least one electricity generation system.

In an advantageous embodiment, the electricity generation systems include generators based on electromagnetic, piezoelectric, electrostatic, solar, triboelectric principles or combinations thereof.

Generators based on the electromagnetic principle comprise electric motors connected in an inverse mode as electric generators.

In one of the advantageous embodiments, the add-on module for autonomous power supply contains a central gearbox comprising a primary gearwheel and at least one secondary gearwheel, which is kinematically connected to the first gearwheel. The first gearwheel has a hole for inserting an axis of the handle, and the add-on module for autonomous power supply also includes at least one rotating main shaft, wherein the number of main shafts is the same as the number of secondary gearwheels. Each secondary gearwheel is connected to one of the main shafts to drive the rotation of this main shaft, each main shaft being connected to either a single electric generator or to a block of at least two electric generators which are kinematically connected to each other.

In advantageous embodiments, the kinematic connection between the primary gearwheel and at least one secondary gearwheel is either direct or comprises at least one transmission component.

In an advantageous embodiment, the transmission components are selected from a group comprising a transmission gearwheel and a transmission rack.

A block of electric generators may comprise at least one sub-block containing at least two electric generators, wherein the individual electric generators are arranged around the main shaft. Each electric generator within the block has its own rotating internal shaft, and the electric generator sub-block is equipped with auxiliary gearwheels for kinematic connection of the internal shafts to the main shaft.

At least two consecutively arranged power generating units may be connected to the main shaft in the longitudinal direction, wherein these units are selected from a group comprising the electric generator and the sub-block of electric generators arranged around the main shaft, wherein together, these consecutively arranged units form a block of electric generators.

In one advantageous embodiment, the electric generators or the blocks of electric generators and the secondary gearwheels are arranged in a star shape around the primary gearwheel, wherein all the secondary gearwheels are kinematically connected to the primary gearwheel through their teeth.

It is advantageous when the add-on module for autonomous power supply comprises a device for processing and storing electrical energy, which is connected to at least one electricity generation system.

In one of the possible embodiments, the device for processing and storing electrical energy may be located on the opposite side of the door leaf than at least one electricity generation system.

At least one electricity generation system may be located on each side of the door leaf.

In an advantageous embodiment, the add-on module for autonomous power supply comprises at least one auxiliary gearbox connected to one of the main shafts or to one of the internal shafts.

### BRIEF DESCRIPTION OF THE DRAWINGS

FIG. 1 shows a detailed example of one possible internal arrangement of the add-on module for autonomous power supply, which takes the form of an insert mounted in a sandwich structure around the door leaf. In this example, the entire add-on module is located on the same side of the door leaf.

FIG. 2 shows the sandwich arrangement of the add-on module for autonomous power supply together with the door fittings and the door. The add-on module is divided into two parts, each of which is placed on a different side of the door leaf.

FIG. 3 shows a detail of the primary gearwheel and the secondary gearwheel which form a part of the central gearbox.

In FIG. 4, one possible arrangement of the electric generators can be seen in a section parallel to the plane of the door leaf. In the picture, there are two sub-blocks of electric generators, which are arranged in a row along the main shaft and form a block of electric generators. The top two electric-generators shown belong to the upper sub-block, the lower ones to the lower sub-block.

In FIG. 5, a section parallel to the plane of the door leaf shows an arrangement with two electric generators placed opposite each other with the central gearbox between them. It is a specific case of a star-shaped arrangement.

FIG. 6 shows a detail of a single electric generator in a section parallel to the plane of the door leaf; in this example, it is an electric generator connected to the secondary gearwheel of the central gearbox via an additional auxiliary gearbox.

In FIG. 7, a star-shaped arrangement of electric generators around the central gearbox is shown in a section parallel to the plane of the door leaf.

In FIG. 8, in a section parallel to the plane of the door leaf, there is another possible arrangement of electric generators around the central gearbox, again in a star-shape.

FIG. 9 shows the generator output voltage waveform when the handle is turned by 45°, measured for one prototype assembly.

FIG. 10 shows the design with the transmission component.

FIG. 11 shows an embodiment in which the add-on module for autonomous power supply is driven by the movement of the entire door leaf.

### DETAILED DESCRIPTION

The preferred embodiments described below show only some of the many possible solutions that fall within the scope of protection of the invention and illustrate the inventive idea. These are only selected advantageous arrangements that do not limit the scope of protection of the invention in any way.

We will use the term door fittings in its standard meaning, where door fittings include all mechanisms and coverings related to operation of the handle, even for embodiments with some parts made of plastic or other materials.

The concept of the add-on module 8 for autonomous power supply and the associated parts assembly is as follows:

From the point of view of the typical door fittings arrangement, this can be seen as a set of two symmetrical parts, each mounted on the opposite side of the door leaf 7. The connection between these two parts is secured by the axis 10 of the handle, which is a long bar usually made from metal and of square cross-section that passes through the door and has the handle fitted on both sides. This axis also passes through the body of the door fittings 9. From the point of view of the possible application of the energy harvesting principle, it is necessary to take into account the only possible mechanical motion, which is created by the user by taking the handle and turning it clockwise around the axis of the handle by approx. 45°. This motion must be transferred using a suitable method to the electricity generator itself, which then converts it into electric energy. For this purpose, in the most advantageous embodiment of the invention, a mechanical central gearbox, typically a 90° one, is used to transfer mechanical power between the axis of the handle and a small electric motor with a cascade gearbox set to a ratio of 250:1 (any ratio can be used, this is only one possible example), which functions in the opposite sense as an electric generator 5 (it is driven by mechanical power which it converts into electricity). In the case of the above example of embodiment, this gearing leads to multiple (250*ratio of the 90° gearbox) rotations of the electric generator 5 and generation of electricity. Generated electricity is then processed by the downstream device 6 for processing and storing electrical energy, which incorporates power management circuitry and includes storage for generated energy in the form of a battery or a supercapacitor.

As this electromechanical system requires a certain amount of space, it is not possible to ensure that all manufacturers of door fittings provide sufficient space in the bodies of their products to accommodate the above parts. Therefore, the entire device was implemented as an add-on module 8 for autonomous power supply, which takes the form of an insert or inlay, the projection of which is usually identical to the projection of the handle fittings in terms of mechanical dimensions, but the height of this add-on module corresponds to the height of the electricity generation system used, which is housed inside of this module 8. The commercial handle is therefore installed over this insert, where the overall thickness of the fittings increases on at least one side. The add-on module 8 for autonomous power supply forms a sandwich structure together with the door fittings body and the door itself. This increases the installation thickness of the fittings, but despite this increase, most handle axes are long enough to connect the two parts of the door fittings.

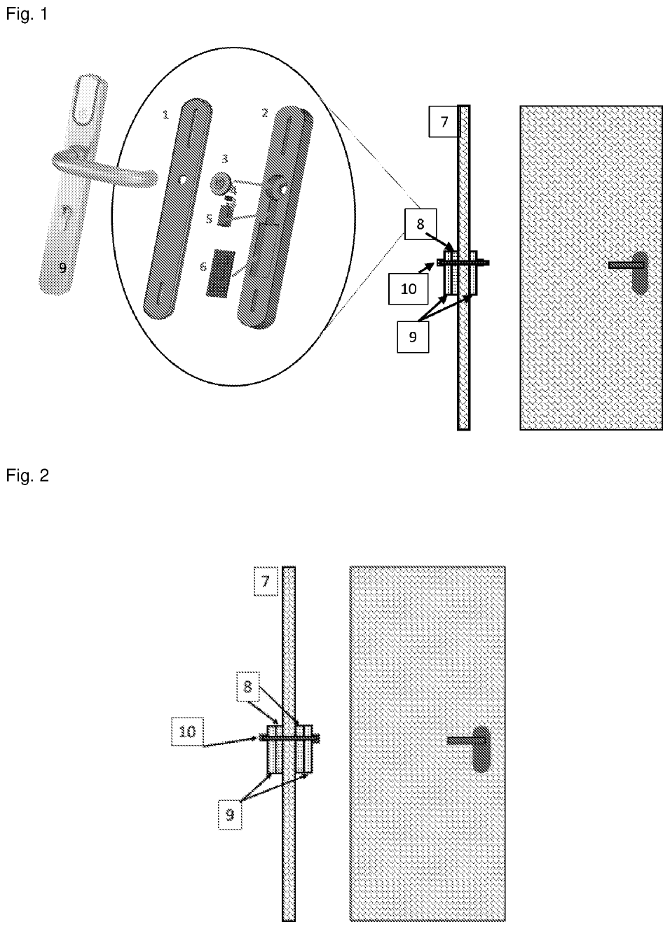

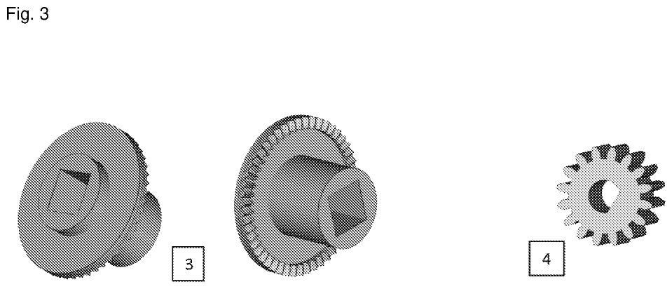

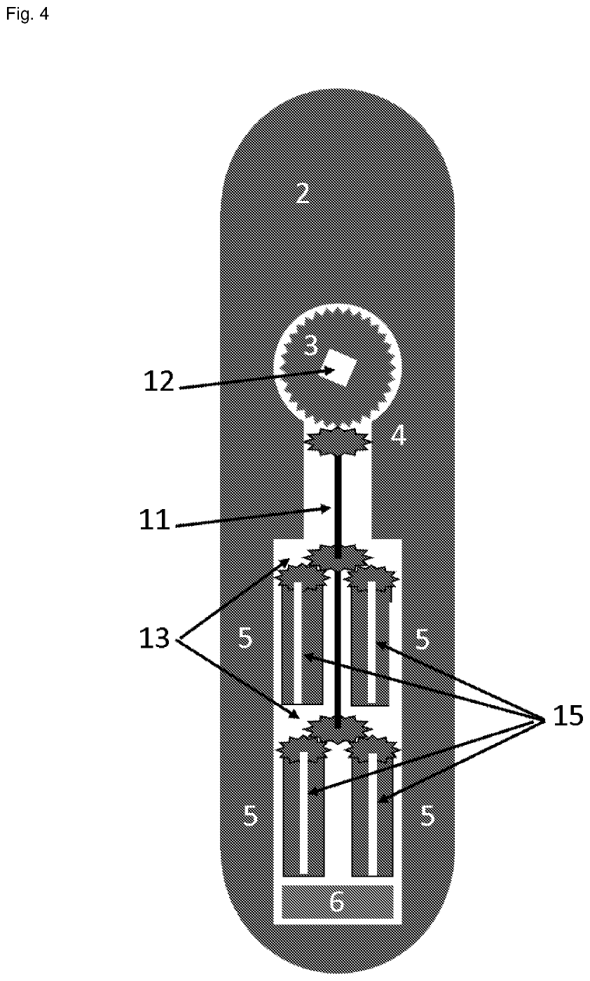

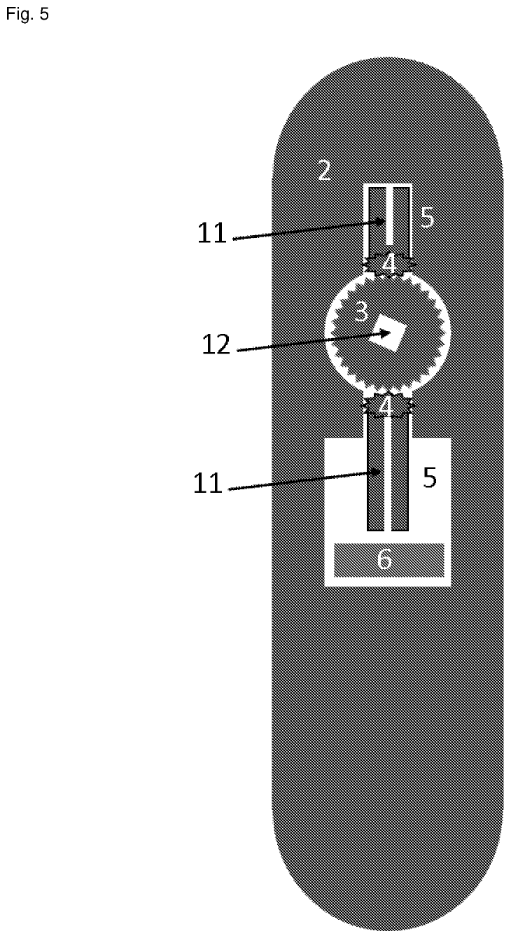

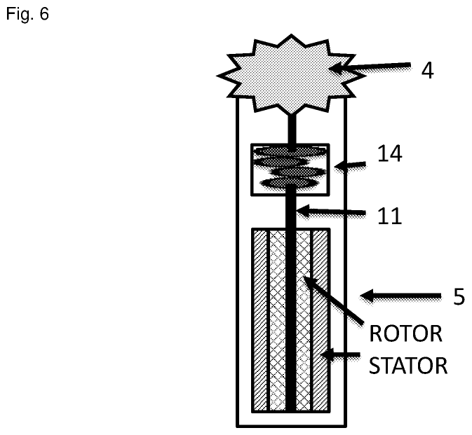

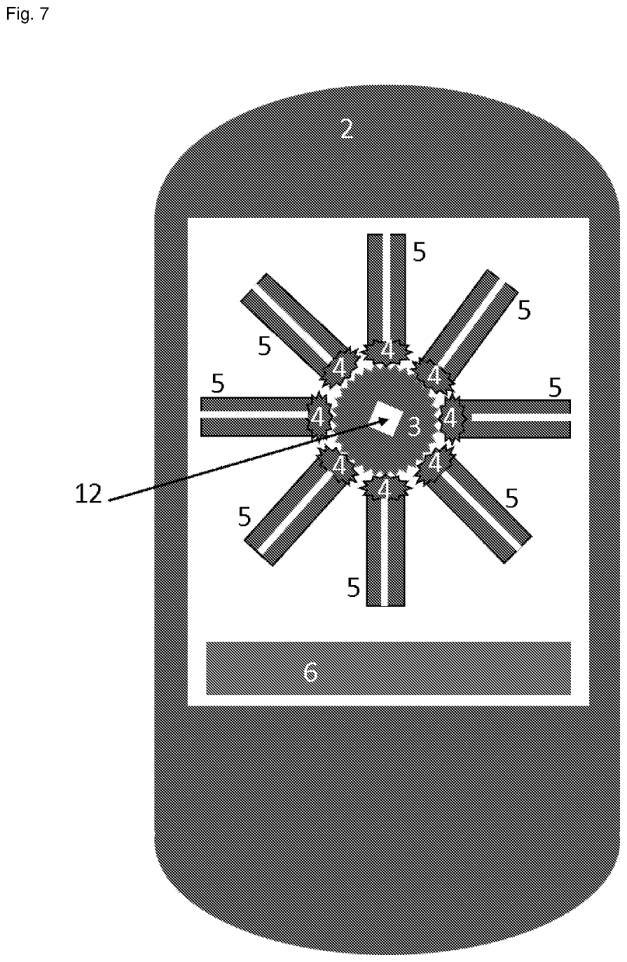

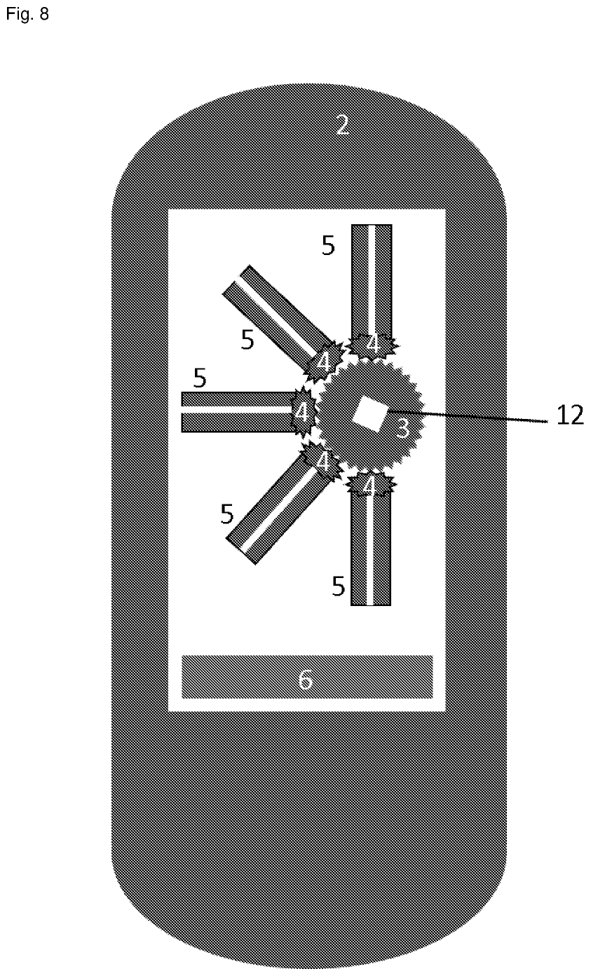

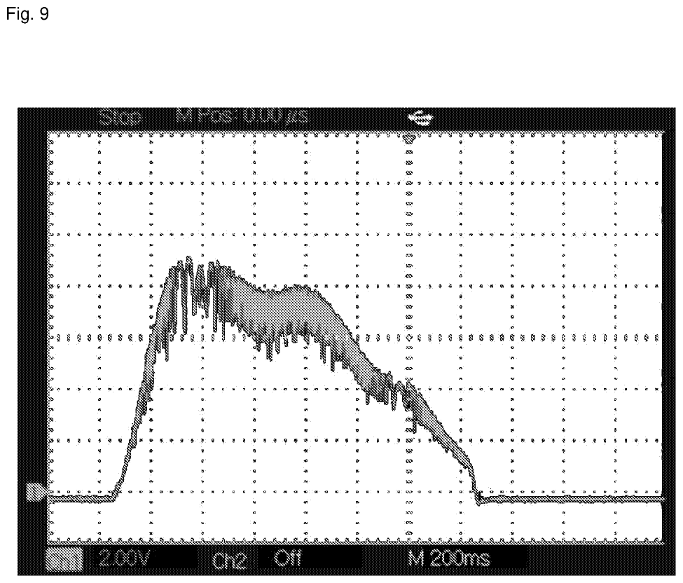

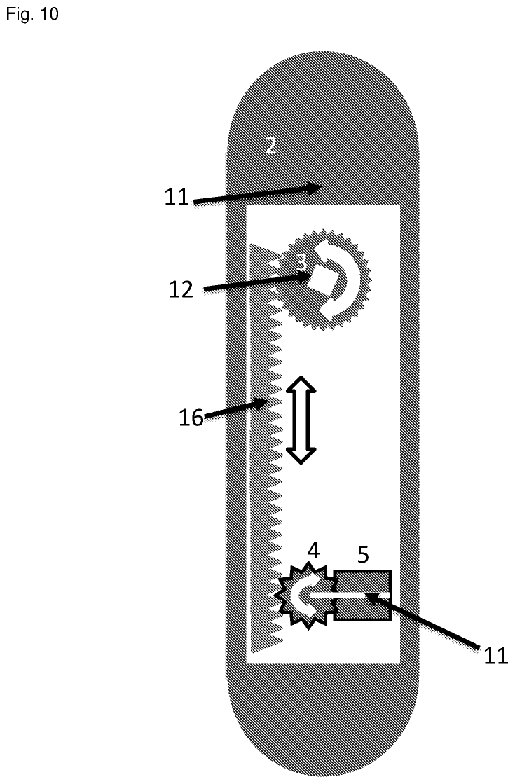

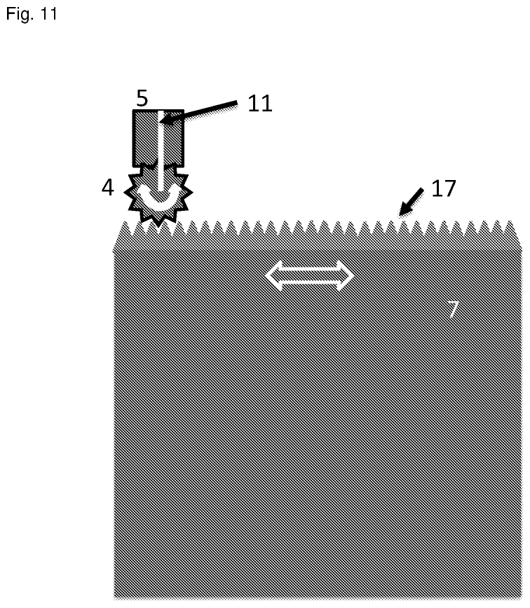

The detail in FIG. 1 also shows some of the details of the add-on module 8 for autonomous power supply in one preferred embodiment. The cover 1 of the add-on module 8 is used to cover the supporting part 2 of the add-on module 8. The supporting part 2 contains the central gearbox which can be arranged in different ways. It can be a 90° gearbox with A:B gearing, where the numbers A and B are chosen to suit specific fittings, door and operation. As one of many options, a prototype with A:B ratio=3.1:1 was tested successfully. This central gearbox contains the primary gearwheel wheel 3 and the secondary gearwheel 4. A detail of both of these gearwheels 3, 4 in one preferred embodiment is shown in FIG. 3: The primary gearwheel 3 with a hole for the axis 10 of the handle, where in this example, the hole is square, is mounted on the axis 10 of the handle, which, after mounting the door fittings, passes through the hole to which the arrow from the primary gearwheel 3 points. The secondary gearwheel can be mounted e.g. on the main shaft 11 of an electric generator or a block of electric generators with an auxiliary gearbox 14 with a C:D ratio, which is again selected to suit the given solution; a detail of one possible arrangement with this auxiliary gearbox 14 is shown in FIG. 6. For example, auxiliary gearbox 14 with C:D=250:1 has been tested with success. The electric generator 5 or the block of electric generators 5 is inserted into the gap the position of which is indicated by the arrow leading from the electric generator 5 in the detail in FIG. 1. Electrical cables run from the electric generator or block of electric generators to the device 6 for processing and storing electric energy which includes a printed circuit board with power management circuitry.

Turning the handle by the angle given by its pressing down by the user causes the primary gearwheel 3 to spin, this motion is transferred to the secondary gearwheel 4, which rotates the main shaft 11 of the electric generator 5 or the block of electric generators 5, which generates electricity; the electricity is stored in the energy storage integrated on the printed circuit board within the device 6 for processing and storing electric energy.

In general, the add-on module 8 for autonomous power supply comprises at least one part, wherein each of the parts of the add-on module 8 for autonomous power supply is inserted between at least a part of the door fittings 9 and the door leaf 7. Of course, door fittings with a lock are also possible, in which case the module 8 is typically covered only by the upper part of the door fittings 9.

In an advantageous embodiment, the add-on module 8 for autonomous power supply may comprise at least two parts, wherein at least one of these parts is located on an opposite side of the door leaf 7 than at least one other part of the add-on module 8 for autonomous power supply. This is shown schematically in FIG. 2.

For example, this may be the case in situations where the device 6 for processing and storing electrical energy may be located on the opposite side of the door leaf 7 than at least one electricity generation system. Another variant of this embodiment is also one in which at least one electricity generation system may be located on each side of the door leaf 7.

In FIG. 2, it can also be clearly seen that in the area where the add-on module 8 for autonomous power supply is located, the assembly has a sandwich structure, wherein the successive layers of the sandwich structure are the door fittings 9, at least one part of the add-on module 8 for autonomous power supply, the door leaf 7, at least one part of the add-on module 8 for autonomous power supply and the door fittings 9.

In contrast, FIG. 1 shows an embodiment in which the entire add-on module 8 for autonomous power supply is on the same side of the door leaf 7, in this example on the left. It can be seen that in the area where the add-on module 8 for autonomous power supply is located, the assembly has once again a sandwich structure, wherein the successive layers of the sandwich structure are the door fittings 9, the add-on module 8 for autonomous power supply or at least one part thereof, the door leaf 7 and the door fittings 9.

In an advantageous embodiment, the add-on module 8 for autonomous power supply comprises at least one electricity generation system. However, this is only one of the possible embodiments; an embodiment in which the add-on module 8 is only equipped with a battery, etc. is also possible.

The electricity generation systems used may include generators based on electromagnetic, piezoelectric, electrostatic, solar, triboelectric principles or combinations thereof.

In one preferred embodiment, the generators based on the electromagnetic principle comprise electric motors connected in an inverse mode as electric generators 5.

FIGS. 4, 5, 7 and 8 and 10 show some possible internal arrangements of the add-on module 8 for autonomous power supply suitable for harvesting energy from the motion of the door handle. They have in common that the add-on module 8 for autonomous power supply contains a central gearbox comprising a primary gearwheel 3 and at least one secondary gearwheel 4, which is kinematically connected to the primary gearwheel 3. The primary gearwheel 3 has a hole 12 for inserting an axis 10 of the handle. The addon module 8 for autonomous power supply also includes at least one rotating main shaft 11. The number of main shafts 11 is the same as the number of secondary gearwheels 4, each secondary gearwheel 4 being connected to one of the main shafts 11 to drive the rotation of this main shaft 11. Each main shaft 11 is connected to either a single electric generator 5 or to a block of at least two electric generators 5 which are kinematically connected to each other.

The kinematic connection between the primary gearwheel 3 and the secondary gearwheel 4 may be direct in some preferred embodiments, see FIGS. 4, 5, 7 and 8, wherein the teeth of the primary gearwheel 3 and the teeth of one or more secondary gearwheels 4 engage.

However, a kinematic connection of another type is also possible; it is sufficient if the rotation of the primary gearwheel 3 somehow, even indirectly, causes the movement of at least one secondary gearwheel 4, which drives one of the electric generators 5. Thus, the kinematic connection between the primary gearwheel 3 and the secondary gearwheel 4, or between the primary gearwheel 3 and multiple secondary gearwheels 4, may in another preferred embodiment include at least one transmission component.

Such a transmission component may consist or comprise, for example, in a transmission gearwheel, a transmission rack 16, a chain or any other component which ensures that the motion of the primary gearwheel 3 also puts at least one secondary gearwheel 4 in motion. The transmission components can be combined in various ways. FIG. 10 shows an example of an embodiment in which the transmission rack 16 serves as the transmission component. The motion of the transmission rack 16 and the secondary gearwheel 4 is indicated in FIG. 11 with arrows. The transmission rack 16 may also ensure the movement of multiple of secondary gearwheels 4, which may be positioned adjacent to the depicted secondary gearwheel 4 along a line parallel to the direction of movement of the transfer rack 16. It is also possible to use multiple transmission racks 16, for example so that the teeth of each of them engages the teeth of at least one of the secondary gearwheels 4.

Such a transmission component can also consist in or comprise any mechanical element that ensures the movement of the secondary gearwheel 4. This includes mechanical pull rods, pistons and similar mechanical gearboxes and their modifications. Such transmission elements are particularly suitable for embodiments not shown in the attached drawings, where any of the gearwheels 3, 4 may be replaced by a non-geared component with an analogous function, i.e. where any component or assembly of components enabling the transfer of mechanical energy to the rotation of the part replacing the secondary gearwheel 4 is used instead of the primary gearwheel 3, where this rotating component drives the electric generator 5.

The shaft connected to the secondary gearwheel 4 is always designated the main shaft 11. This may be the main axis of rotation of one of the electric generators 5, see for example FIG. 5, where the axis of rotation of each of the electric generators 5 is directly connected to the secondary gearwheel 4 and thus serves as the main shaft 11. However, other arrangements are also possible, see for example FIG. 4, which shows a more complex arrangement of electric generators 5. In FIG. 4, the central axis passing through two sub-blocks forming one block of electric generators is the main axis 11. However, in the embodiment according to FIG. 4, additional internal shafts 15 are used which are not directly connected to the secondary gearwheel 4 of the central gearbox, as described below.

The arrangement according to FIG. 4, illustrating the use of a block of electric generators 5, may have other variants with a different number of electric generators.

In general, a variant in which the block of electric generators 5 comprises at least one sub-block of at least two electric generators 5 connected in parallel is possible. There are two such sub-blocks in FIG. 4. The upper two generators 5 belong to the upper sub-block, the lower two generators 5 to the lower sub-block. Within each sub-block, the individual electric generators 5 are arranged around the main shaft_1_1, where each electric generator 5 within the block has its own rotating internal shaft 15. Each electric generator sub-block is equipped with auxiliary transmission gearwheels 13 for kinematic connection of the internal shafts 15 to the main shaft 11.

As illustrated in FIG. 4, these sub-blocks can also be arranged in series (in sequence). Alternatively, it is possible to arrange sub-blocks consisting of or comprising several electric generators 5 connected in parallel and individual electric generators 5 in any number and order one after the other, i.e. several sub-blocks or several individual electric generators 5 may be arranged one after another, or these units may alternate in different ways. Generally speaking, at least two power generating units arranged in series may be connected to the main shaft 11 in the longitudinal direction, wherein these units are selected from a group comprising the electric generator 5 and the sub-block of electric generators 5 arranged around the main shaft 11, wherein together, these units arranged in series form a block of electric generators 5. The arrangement of the block of electric generators 5 shown in FIG. 4 can also be applied in embodiments with transmission components, e.g. in FIG. 10, one electric generators 5 shown in this Fig. can be replaced by a block of generators 5 in an arrangement analogous to that shown in FIG. 4.

FIGS. 5, 7 and 8 show examples of star-shaped central gearbox arrangements. For simplicity, only the individual electric generators 5 are shown here, but each of these electric generators can also be replaced by a block of electric generators 5 connected in parallel, in series or in a series-parallel circuit as described above. As one possible example, it can be stated that any of the electric generators 5 in FIGS. 5, 7 or 8 may be replaced by, for example, a block of electric generators 5 according to FIG. 4, but also by a block of electric generators 5 in other configurations. Generally speaking, the electric generators 5 or the blocks of electric generators 5 and the secondary gearwheels 4 may be arranged in a star shape around the primary gearwheel 3, wherein all the secondary gearwheels 4 are kinematically connected to the primary gearwheel 3 through their teeth. For the sake of clarity, the main shafts 11 in these star-shaped arrangements are only marked with a reference sign in FIG. 5, but they are also present in the more complex star-shaped arrangements according to FIGS. 7 and 8.

The add-on module 8 for autonomous power supply also comprises a device 6 for processing and storing electrical energy, i.e. power management, which is connected to at least one electricity generation system. This device typically contains a printed circuit board populated with components and a battery for storing produced electricity. It is electrically connected to the electric generator 5, typically using cables.

FIG. 6 shows an embodiment of one electric generator 5 connected to the secondary gearwheel 4 of the central gearbox via another, auxiliary gearbox 14. The add-on auxiliary gearbox 14 may be connected to any of the electric generators 5 or blocks of electric generators 5 in the above-described arrangements. Generally speaking, the add-on module 8 for autonomous power supply comprises at least one auxiliary gearbox 14 connected to one of the main shafts 11 or to one of the internal shafts 15.

It can be seen that the described arrangements allow various modifications to increase the output power.

The above configuration can be modified in several ways to optimise output power.
by increasing the transmission ratio of the gearboxes
by using more powerful electric generators 5
by scaling up the existing structure

Given the mechanical arrangement of the individual parts inside, the last option presents the opportunity to multiply the number of used electric generators 5. For example, in the case of an embodiment according to FIG. 4, in which there are 4 electric generators 5, the subjective feeling of the user is that it is necessary to exert a relatively greater force to move the handle than in a single-generator configuration, but the output power is increased by 300%. This configuration places increased demands on the strength and accuracy of the gearboxes and shafts 11, 15.

A prototype of the assembly according to an aspect of the present invention was constructed using a 3D printer, which was used, for example, to manufacture all gearwheels 3, 4, 13. A commercially available electric generator 5 with an integrated auxiliary gearbox 14 with a 250:1 ratio was purchased. A printed circuit board with electronics for a device 6 for processing and storing electrical energy was manufactured.

FIG. 9 shows the course of the rectified output voltage of the electric generator in the prototype corresponding to FIG. 5, but with only one electric generator 5, this electric generator 5 being connected to the central gearbox via another auxiliary gearbox 14 in accordance with FIG. 6. When the handle is turned by 45° in one direction and back, a charge of 200 mC is generated in full-wave rectification. This charge is then processed in power management circuits where it is adjusted to the appropriate voltage required by the powered downstream devices (intelligent door systems, etc.). When using groups of 5 electric generators, it is possible to achieve adequately higher generated charges and thus higher current at the same voltage.

FIG. 11 shows another possible embodiment of the add-on module 8 for autonomous power supply, which includes a central gearbox. The source of the generated electrical energy is not the motion of the handle, but the motion of the entire door leaf 7. The door leaf 7, which is sliding, is connected to the primary rack 17. The movement of the primary rack 17 mounted on the door leaf 7 rotates the secondary gearwheel 4, which rotates the main shaft 11 and thus drives the electric generator 5 or the generator block 5 (the version with the generator block 5 is not shown in the drawings, but is analogous to the embodiment in FIG. 4). The primary rack 17 may also drive multiple of secondary gearwheels 4, which may be positioned adjacent to the depicted secondary gearwheel 4 along a line parallel to the direction of movement of the primary rack 17.

It is also possible to use multiple primary racks 17, for example so that the teeth of each of them engages the teeth of at least one of the secondary gearwheels 4. In an advantageous embodiment, the primary rack or racks 17 are located at that edge or edges of the door leaf 7 which are parallel to the direction of sliding of the door leaf 7. The secondary gearwheel or gearwheels 4 have their rotation axis fixed to a solid structure outside the door leaf 7 so that it does not move together with the door leaf 7 itself.

The motion of the primary rack 17 and the secondary gearwheel 4 is indicated in FIG. 11 with arrows. In the embodiment according to FIG. 11, the primary rack 17 fulfils the same role as the primary gearwheel 3 in the embodiments according to FIGS. 4, 5, 7, 8 and 10—i.e. its motion is the primary source of energy that subsequently puts in rotation at least one secondary gearwheel 4 driving the electric generator 5 or the block of electric generators 5. The embodiment according to FIG. 11 differs from the embodiments according to FIGS. 4, 5, 7, 8 and 10 by the placement of the add-on module 8 for autonomous power supply, where the power source is the motion of the handle and the add-on module 8 for autonomous power supply is located under the door fittings near the handle. Nevertheless, other principles of energy generation based on the motion required to open the door are similar.

In the embodiments according to FIGS. 4, 5, 7, 8, 10 and 11, the source of energy for the add-on module 8 for autonomous power supply is always a mechanical motion, typically the motion performed by the user when opening the door.

The door leaf assembly with door fittings equipped with a mechanically operated handle and an add-on module for autonomous power supply can be used wherever door fittings with integrated electronics serving as an access management system are used. These systems are most common in commercial office buildings where room access rights need to be set for different groups of people. The add-on module will become an integral part of these intelligent door systems and thanks to its ability to generate electrical energy from the motion caused by the user, the energy requirements are partially covered from the energy generated by this generator and, in general, the operating time of the device is extended, thus extending the time between necessary service interventions.

The proposed solution is most suitable for manufacturers of door fittings and the manufacturers of access management systems.

However, the energy produced by the add-on module for autonomous power supply can also be used for various purposes other than access management systems; it can be used to power virtually any device for which the amount of energy generated is sufficient. The add-on module for autonomous power supply can be used for a wide variety of door systems.

### REFERENCE SIGNS LIST

1—cover of the add-on module
2—supporting part of the add-on module
3—primary gearwheel
4—secondary gearwheel
5—electric generator
6—device for processing and storing electrical energy
7—door leaf
8—add-on module for autonomous power supply
9—door fittings
10—axis of the handle
11—main shaft (of the electric generator or the block of electric generators, it is connected to the
secondary gearwheel 4)
12—hole
13—auxiliary transmission gearwheels
14—auxiliary gearbox
15—internal shaft (inside of the block of electric generators; this internal shaft is not directly
connected to the secondary gearwheel 4)
16—transmission rack
17—primary rack

1. A door leaf assembly with door fittings (equipped with an add-on module for autonomous power supply, comprising a mechanically operated handle, wherein the add-on module for autonomous power supply comprises at least one part, wherein each of the parts of the add-on module for autonomous power supply is inserted between at least a part of the door fittings and the door leaf.

2. The assembly according to claim 1, wherein the add-on module for autonomous power supply comprises at least two parts, wherein at least one of these parts is located on an opposite side of the door leaf than at least one other part of the add-on module for autonomous power supply.

3. The assembly according to claim 1, wherein in the area where the add-on module for autonomous power supply is located, the assembly has a sandwich structure, wherein the successive layers of the sandwich structure are the door fittings, the add-on module for autonomous power supply or at least one part thereof, the door leaf and the door fittings.

4. The assembly according to claim 2, wherein in the area where the add-on module for autonomous power supply is located, the assembly has a sandwich structure, wherein the successive layers of the sandwich structure are the door fittings, at least one part of the add-on module for autonomous power supply, the door leaf, at least one part of the add-on module for autonomous power supply and the door fittings.

5. The assembly according to claim 1 any of claims 1 to 4, wherein the add-on module for autonomous power supply comprises at least one electricity generation system.

6. The assembly according to claim 5, wherein the electricity generation systems include generators based on electromagnetic, piezoelectric, electrostatic, solar, triboelectric principles or combinations thereof.

7. The assembly according to claim 6, wherein generators based on the electromagnetic principle comprise electric motors connected in an inverse mode as electric generators.

8. The assembly according to claim 7, wherein the add-on module for autonomous power supply contains a central gearbox comprising a primary gearwheel and at least one secondary gearwheel, which is kinematically connected to the primary gearwheel, wherein the primary gearwheel has a hole for inserting an axis of the handle, and the add-on module for autonomous power supply also includes at least one rotating main shaft, wherein the number of main shafts is the same as the number of secondary gearwheels, each secondary gearwheel being connected to one of the main shafts to drive the rotation of this main shaft, each main shaft being connected to either a single electric generator or to a block of at least two electric generators which are kinematically connected to each other.

9. The assembly according to claim 8, wherein the kinematic connection between the primary gearwheel and at least one secondary gearwheel is either direct or comprises at least one transmission component.

10. The assembly according to claim 9, wherein the transmission components are selected from a group comprising a transmission gearwheel and a transmission rack.

11. The assembly according to claim 8, wherein a block of electric generators comprises at least one sub-block containing at least two electric generators, in which the individual electric generators are arranged around the main shaft, where each electric generator within the block has its own rotating internal shaft, and wherein the electric generator sub-block is equipped with auxiliary transmission gearwheels for kinematic connection of the internal shafts to the main shaft.

12. The assembly according to claim 8, wherein at least two power generating units arranged in series are connected to the main shaft in the longitudinal direction, wherein these units are selected from a group comprising the electric generator and the sub-block of electric generators arranged around the main shaft, wherein together, these units arranged in series form a block of electric generators.

13. The assembly according to claim 8, wherein the electric generators or the blocks of electric generators and the secondary gearwheels are arranged in a star shape around the primary gearwheel, wherein all the secondary gearwheels are kinematically connected to the primary gearwheel through their teeth.

14. The assembly according to claim 5, wherein the add-on module for autonomous power supply comprises a device for processing and storing electrical energy, which is connected to at least one electricity generation system.

15. The assembly according to claim 5, wherein the device for processing and storing electrical energy is located on the opposite side of the door leaf than at least one electricity generation system.

16. The assembly according to claim 5, wherein at least one electricity generation system is located on each side of the door leaf.

17. The assembly according to claim 8, wherein the add-on module for autonomous power supply also comprises at least one auxiliary gearbox connected to one of the main shafts or to one of the internal shafts.
